(19) United States
(12) Patent Application Publication
(10) Pub. No.: US 2008/0106394 A1
(43) Pub. Date: May 8, 2008

(54) MULTI-PORT TIRE PRESSURE DETECTING SYSTEM

(76) Inventor: Teng-Wen Huang, Panchiao City (TW)

Correspondence Address: PAI PATENT & TRADEMARK LAW FIRM, 1001 FOURTH AVENUE, SUITE 3200, SEATTLE, WA, 98154, US

(21) Appl. No.: 11/682,310

(22) Filed: Mar. 5, 2007

(30) Foreign Application Priority Data
Nov. 2, 2006 (TW) 95140616

(51) Int. Cl. B60C 23/00

(52) U.S. Cl. 340/445

(57) ABSTRACT

A multi-port tire pressure detecting system includes a plurality of pressure detection units and a pressure processing unit. Each of the pressure detection units is mounted to an inflation valve on a tire via a tire pressure inlet port, and includes an internal pressure detector and an outward projected pumping inlet port. The pressure processing unit includes a microprocessor, a transmitter, and a power supply connected to the microprocessor, the transmitter, and the pressure detectors for supplying power thereto. When the pressure detectors detect the pressure of tires, tire pressure data are generated. The generated tire pressure data are processed by the microprocessor and then transmitted by the transmitter to a receiving unit near a driver seat for display in real time. When a tire is indicated as having insufficient internal pressure, the tire may be conveniently inflated via the pumping inlet port of a corresponding pressure detection unit.

### RELATED APPLICATIONS

The present application is based on, and claims priority from, Taiwan Application Serial Number 95140616, filed Nov. 2, 2006, the disclosure of which is hereby incorporated by reference herein in its entirety.

### FIELD OF THE INVENTION

The present invention relates to a tire pressure detecting system, and more particularly to a multi-port tire pressure detecting system that allows detection of internal pressure of a plurality of tires parallelly arranged at the same side of one wheel axle, and pumping of a tire of insufficient pressure without the need of removing the tire pressure detecting system from an inflation valve of the tire.

### BACKGROUND OF THE INVENTION

Most of currently available tire inflators or tire pressure detectors are designed for mounting to an inflation valve on a tire, so as to detect the internal pressure of the tire. A conventional tire inflator mainly includes a pumping valve, a pressure gauge, and an air inlet controller, and is connected to an air compressor, so that a user may control the air inlet controller to introduce high-pressure air from the air compressor into the tire via the pumping valve. Meanwhile, the pressure gauge measures the internal pressure of the tire at the same air passage. Since it is uneasy to preset a standard pressure value on the pressure gauge for the tire, the tire tends to be excessively or insufficiently pumped. Therefore, it is necessary for the user to repeatedly release air from and/or pump air into the tire. This would cause a lot of troubles in inflating the tire or even result in danger in driving.

Taiwanese Patent Publication No. 578706 discloses a tire pressure detector that is directly mounted in a tire. While the tire pressure detector disclosed in Taiwanese Patent Publication No. 578706 enables convenient detection of the tire pressure, it could not be easily mounted in or dismounted from the tire. To enable convenient mounting and use of a tire pressure detector, most currently available tire pressure detectors are designed for directly mounting to the inflation valve that is located at an outer side of the tire. However, the tire pressure detector mounted on the inflation valve would cause inconvenience in pumping the tire. And, it is still uneasy to preset the tire pressure detector to a correct pressure value to properly pump the tire. In addition, while general auto vehicles have only one tire mounted to each side of a wheel axle, big-scale vehicles, including combination vehicles and heavy trucks as shown in FIG. 1, usually have a plurality of tires 11 parallelly mounted to each side of one wheel axle. Generally, there are two tires parallelly mounted to each side of the same one wheel axle for bearing the weight of the vehicle and the cargo thereof. In case one of the two tires, such as an inner tire 11a thereof, is flattened or damaged, the other outer tire 11b may still function to bear the weight of the vehicle.

Each of the parallelly arranged tires may have an independent tire pressure detector mounted thereto for detecting the tire pressure and indicating any abnormal tire condition at any time. However, whenever any one of the tires is detected as having abnormal tire pressure, such as insufficient tire pressure, the tire pressure detector on that tire must be dismounted from the inflation valve of the tire before the tire can be pumped via the inflation valve using a tire inflator. The tire pressure detector is then re-mounted to the inflation valve of the tire when the tire has been pumped. Therefore, the mounting of the conventional external type tire pressure detector to the inflation valve on the tire would cause inconveniences in pumping the tire, particularly when there are two or more tires being arranged side by side on the wheel axle. This is because the inner tire 11a is spatially hindered by the outer tire 11b, and the location of the inflation valve on the inner tire 11a is not easily accessible for pumping. When any one of the two parallelly arranged tires, particularly the inner one, is detected as having insufficient tire pressure, a user has to troublesomely and laboriously dismount the tire pressure detector from the tire, pump the tire, and then remount the tire pressure detector.

It is therefore desirable to develop an improved tire pressure detector to save a driver the above-mentioned inconveniences and confusions in pumping a tire.

### SUMMARY OF THE INVENTION

A primary object of the present invention is to provide a multi-port tire pressure detecting system for mounting to a plurality of tires parallelly arranged at the same side of one wheel axle to detect the pressure of the plurality of tires at the same time.

Another object of the present invention is to provide a multi-port tire pressure detecting system that allows pumping of any tire having insufficient tire pressure without the need of removing the tire pressure detecting system from the tire.

To achieve the above and other objects, the multi-port tire pressure detecting system according to the present invention includes a plurality of pressure detection units and a pressure processing unit. Each of the pressure detection units is mounted to an inflation valve on a tire via a tire pressure inlet port, and includes an internal pressure detector and an outward projected pumping inlet port. The pressure processing unit includes a microprocessor connected to the pressure detectors, a transmitter connected to the microprocessor, and a power supply connected to the microprocessor, the transmitter, and the pressure detectors for supplying power thereto. When the pressure detectors detect the pressure of tires, tire pressure data are generated. The generated tire pressure data are processed by the microprocessor and then transmitted by the transmitter to a receiving unit in the vicinity of a driver seat for display in real time. When a tire is indicated as having insufficient internal pressure, the tire may be conveniently inflated via the pumping inlet port of a corresponding pressure detection unit.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows the arrangement of tires for a general big-scale vehicle;

FIG. 2 schematically shows the mounting of a multi-port tire pressure detecting system of the present invention to a wheel rim;

FIG. 3 is a block diagram of the multi-port tire pressure detecting system of the present invention; and

FIG. 4 is a sectional view of a pressure detection unit included in the multi-port tire pressure detecting system of the present invention.

### DETAILED DESCRIPTION OF THE PREFERRED EMBODIMENTS

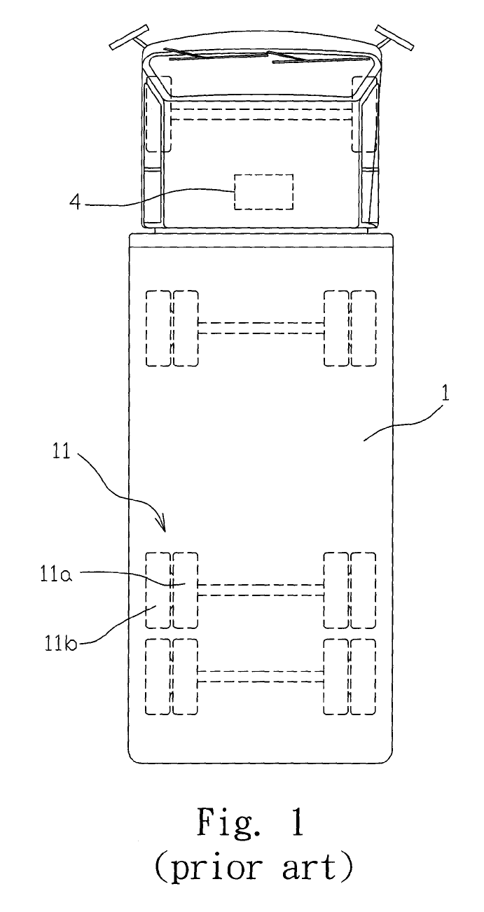

Please refer to FIG. 1. A general big-scale vehicle 1, such as a combination vehicle, a heavy truck, etc., normally includes a plurality of tires 11 parallelly mounted to each side of a wheel axle. On the vehicle illustrated in FIG. 1, there are two tires, namely, a first or inner tire 11a and a second or outer tire 11b, parallelly mounted to each side of one wheel axle. A multi-port tire pressure detecting system A according to the present invention is designed for detecting internal pressure of the tires parallelly mounted to the same side of each wheel axle.

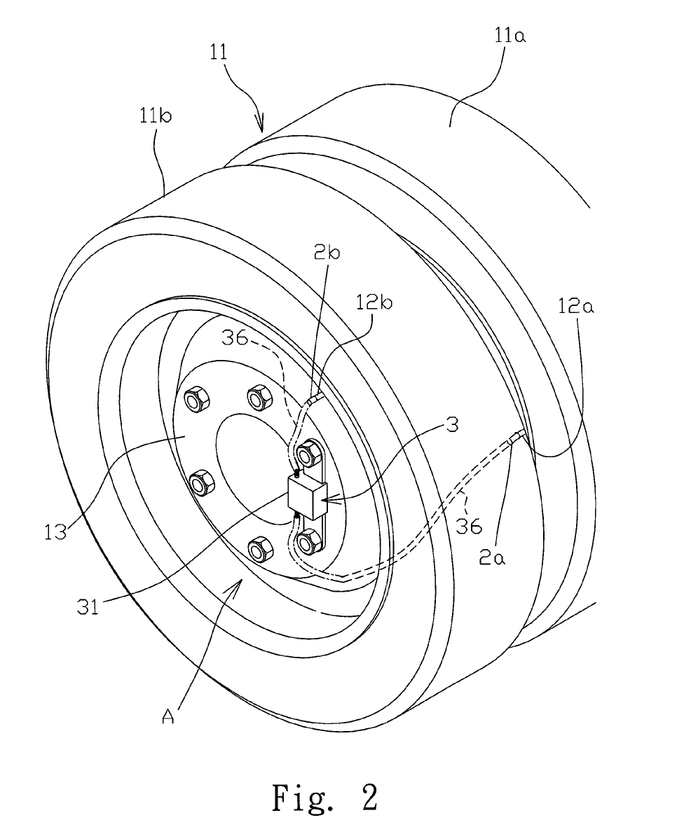

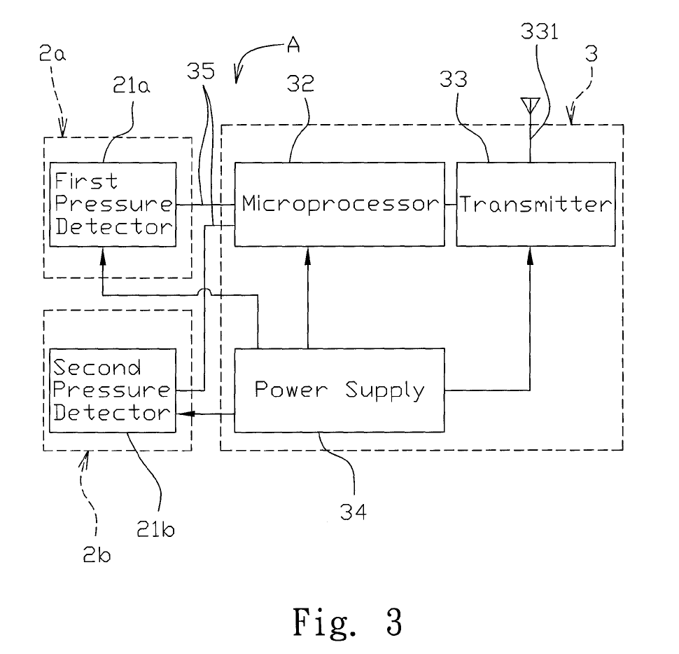

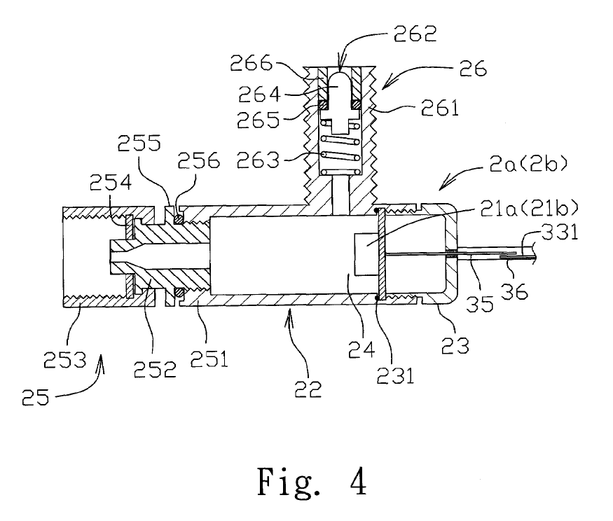

Please refer to FIGS. 2, 3, and 4. The multi-port tire pressure detecting system A includes a first pressure detection unit 2a, a second pressure detection unit 2b, and a pressure processing unit 3.

Since it is illustrated in FIG. 1 that two tires are parallelly mounted to each side of one wheel axle, the phrase of “a plurality of tires” appeared throughout the specification of the present invention shall refer to “two tires”.

The two tire pressure detection units 2a, 2b are respectively mounted to inflation valves 12a, 12b on the first and the second tire 11a, 11b, and are internally provided with a first and a second pressure detector 21a, 21b, respectively, for detecting the internal pressure of the first and the second tire 11a, 11b.

The first and the second tire pressure detection unit 2a, 2b have identical structure, and each of which includes a main body 22 and a cap 23. The cap 23 is closed to an end of the main body 22 via a third oil seal ring 231; such that an airtight chamber 24 is formed in a space enclosed in the main body 22 and the cap 23. The first or the second pressure detector 21a or 21b is mounted in the airtight chamber 24. Further, a tire pressure inlet port 25 and a pumping inlet port 26 are provided on the main body 22 to communicate with the airtight chamber 24.

The tire pressure inlet port 25 includes a coupling mouth 251 outward projected from the main body 22, a valve 252 screwed to and outward projected from the coupling mouth 251, and a turnable union 253 externally mounted around the valve 252 for screwing to the inflation valve 12a or 12b. While the turnable union 253 is turned to screw to the inflation valve 12a, 12b, all other parts of the tire pressure detection unit 2a, 2b are kept unmoved without turning along with the union 253 to adversely affect any wiring between the tire pressure detection unit 2a, 2b and other related parts. When the turnable union 253 is screwed onto the inflation valve 12a, 12b on the tire 11a, 11b, a valve body (not shown) of the inflation valve is pushed open by the valve 252, allowing the air pressure in the tire 11a, 11b to transmit into the airtight chamber 24 and be detected by the pressure detector 21a, 21b.

An elastic washer 254 is provided between an inner end of the turnable union 253 and the valve 252. The valve 252 is formed around an outer surface with a flange 255, and a first oil seal ring 256 is provided between the flange 255 and the coupling mouth 251. With the elastic washer 254 and the first oil seal ring 256, the turnable union 253, the valve 252, and the coupling mouth 251 are assembled to one another in an airtight manner.

The pumping inlet port 26 includes a pumping mouth 261 outward projected from the main body 22. The pumping mouth 261 is internally provided with a check valve assembly 262, which includes an elastic element 263, a valve body 264, a second oil seal ring 265, and a plug 266 sequentially mounted in the pumping mouth 261. The check valve assembly 262 is a one-way openable valve to prevent air in the airtight chamber 24 from leaking via the pumping inlet port 26. However, when the tire pressure is insufficient, external air may be introduced into the airtight chamber 24 via the pumping inlet port 26 and into the tire 11a, 11b via the valve 252.

The pressure processing unit 3 includes a housing 31, in which a microprocessor 32, a transmitter 33, and a power supply 34 are provided. The microprocessor 32 is connected to the first pressure detector 21a and the second pressure detector 21b via two transmission lines 35. The transmitter 33 is connected to the microprocessor 32. The power supply 34 is connected to the microprocessor 32, the transmitter 33, and the pressure detectors 21a, 21b for supplying power to these parts. The transmitter 33 is connected at an end to an antenna 331, which is extended from an inner side to an outer side of the housing 31.

In practical use of the present invention, the pressure processing unit 3 is fixedly mounted to a wheel rim 13 of an outmost tire, such as the tire 11b, of a plurality of parallelly arranged tires. The transmission lines 35 extended between the pressure processing unit 3 and the pressure detectors 21a, 21b are covered with a protective tube 36 each. The antenna 331 of the transmitter 33 may also be hidden in the protective tube 36.

In the multi-port tire pressure detecting system of the present invention, the pressure detectors 21a, 21b of the first and the second pressure detection unit 2a, 2b may detect the tire pressure of the first and the second tire 11a, 11b, respectively, and generate relevant tire pressure data, which are processed by the microprocessor 32 and then transmitted by the transmitter 33 to a receiving unit 4 located in the vicinity of a driver seat. The received data are processed by the receiving unit 4, so that values of pressure of all tires are shown on a display (not shown) of the receiving unit 4 in real time. Since the processing, transmitting, and receiving of the tire pressure data belongs to general radio transmitting and receiving technology, it is not discussed in details herein.

When it is shown on the receiving unit 4 that any one of the tires has insufficient tire pressure, the tire may be conveniently inflated via the pumping inlet port 26 on the pressure detection unit 2a, 2b without the need of removing the multi-port tire pressure detecting system A from the tire.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A multi-port tire pressure detecting system, being designed to detect tire pressure of a first or inner tire and a second or outer tire parallelly mounted to the same side of one wheel axle, and each of said tires having an inflation valve; said multi-port tire pressure detecting system comprising:
a first pressure detection unit being connected to said inflation valve on said first tire, and internally provided with a first pressure detector for detecting internal pressure of said first tire;
a second pressure detection unit being connected to said inflation valve on said second tire, and internally provided with a second pressure detector for detecting internal pressure of said second tire; and
a pressure processing unit having a housing, in which a microprocessor, a transmitter, and a power supply are provided; said microprocessor being connected to said first and second pressure detectors via transmission lines, said transmitter being electrically connected to said microprocessor, and
said power supply being connected to said microprocessor, said transmitter, and said first and second detectors for supplying power thereto.

2. The multi-port tire pressure detecting system as claimed in claim 1, wherein said pressure processing unit is fixedly mounted to a wheel rim of said second or outer tire of said parallelly arranged tires.

3. The multi-port tire pressure detecting system as claimed in claim 1, wherein said transmission lines are covered with a protective tube each.

4. The multi-port tire pressure detecting system as claimed in claim 1, wherein said transmitter is connected at an end to an antenna, and said antenna being extended from an inner side to an outer side of said housing.

5. The multi-port tire pressure detecting system as claimed in claim 4, wherein said antenna of said transmitter is hidden in a protective tube.

6. The multi-port tire pressure detecting system as claimed in claim 1, wherein both of said first and said second pressure detection unit include a main body, and a cap closed to an end of said main body, such that an airtight chamber is enclosed in said main body and said cap; said first and said second pressure detector being respectively mounted in said airtight chamber of said first and said second pressure detection unit; and said main body being provided at predetermined positions with a tire pressure inlet port and an pumping inlet port, which are communicating with said airtight chamber.

7. The multi-port tire pressure detecting system as claimed in claim 6, wherein said tire pressure inlet port includes a coupling mouth outward projected from said main body, a valve screwed to and outward projected from said coupling mouth, and a turnable union mounted around an outer surface of said valve for screwing to said inflation valve on one said tire.

8. The multi-port tire pressure detecting system as claimed in claim 7, wherein said tire pressure inlet port further includes an elastic washer being mounted between an inner end of said turnable union and said valve.

9. The multi-port tire pressure detecting system as claimed in claim 7, wherein said valve of said tire pressure inlet port is formed around the outer surface with a flange, and a first oil seal ring being mounted between said coupling mouth and said flange.

10. The multi-port tire pressure detecting system as claimed in claim 6, wherein said pumping inlet port includes a pumping mouth outward projected from said main body of said pressure detection unit, and said pumping mouth being internally provided with a check valve assembly.

11. The multi-port tire pressure detecting system as claimed in claim 10, wherein said check valve assembly includes an elastic element, a valve body, a second oil seal ring, and a plug, which are sequentially mounted in said pumping mouth.
